(19) United States
(12) Patent Application Publication
(10) Pub. No.: US 2010/0237269 A1
(43) Pub. Date: Sep. 23, 2010

(54) VALVE DEVICE

(75) Inventors: Akira Furukawa, Kariya-city (JP); Osamu Shimane, Kariya-city (JP); Shinsuke Miyazaki, Chiryu-city (JP); Yuichiro Moritani, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/723,794

(22) Filed: Mar. 15, 2010

(30) Foreign Application Priority Data
Mar. 17, 2009 (JP) 2009-64598
Apr. 28, 2009 (JP) 2009-109370

(51) Int. Cl. F16K 1/00; F16K 27/00; B21D 51/16

(52) U.S. Cl. 251/318; 251/366; 29/890.12

(57) ABSTRACT

An object of the invention for a valve device having an inclined valve body is to suppress pressure loss at a valve opened condition to a smaller amount. The valve body is composed of a disc shaped valve member for closing a fluid passage, a first supporting portion provided at an outer periphery of the valve member and connected to a first shaft member, and a second supporting portion provided at another outer periphery of the valve member and connected to a second shaft member. The valve body is formed of a press-molded metal plate and forms a Z-shape when viewed in a direction parallel to a surface of the valve member.

### CROSS REFERENCE TO RELATED APPLICATION

This application is based on Japanese Patent Application No. 2009-064598 filed on Mar. 17, 2009 and No. 2009-109370 filed on Apr. 28, 2009, the disclosures of which are incorporated herein by reference.

### FIELD OF THE INVENTION

The present invention relates to a valve device having a butterfly valve for opening and closing a fluid passage and also controlling an opening area of the fluid passage, in particular relates to a valve device in which a rotational axis of a shaft for driving a valve body is inclined with respect to a center line of the fluid passage. The present invention may be applied to, for example, an EGR valve device for an engine (an internal combustion engine for producing a power by combustion of fuel) according to which a part of exhaust gas emitted from the engine is re-circulated into an intake air passage.

### BACKGROUND OF THE INVENTION

An EGR valve device will be explained as an example of conventional valve devices.

As disclosed in Japanese Patent Publication No. 2003-184583, a butterfly valve is generally used for the EGR valve device. In the EGR valve device having the butterfly valve, a rotational axis of a shaft for driving the valve is arranged at a right angle to a center line of a fluid passage, wherein an opening area (Q) of the valve is changed in accordance with a rotational angle of the shaft, for example, as shown in FIG. 2 of this application (indicated by a dotted line A).

According to the general EGR valve device, a relationship between the opening area (Q) of the EGR valve and the rotational angle of the shaft is described by a sine curve (as shown by the dotted line A in FIG. 2). It is said that air-flow resistance at a valve (fully) opened condition is small.

Another type of an EGR valve device also having a butterfly valve is known in the art, for example, as disclosed in Japanese Patent Publication No. 2007-285311, according to which a rotational axis of a shaft for driving a valve body is inclined with respect to a center line of a fluid passage.

According to the conventional EGR valve device of this kind, the valve body is fixed to a forward end of the shaft, in which the axis of the shaft is inclined with respect to the center line of the fluid passage, so that an opening characteristic (an opening area) of the valve device with respect to the rotational angle of the shaft may become a linear relationship in order to make it easier to control EGR amount. For example, the opening area (Q) with respect to the rotational angle of the shaft is controlled to be such opening characteristic, as shown in FIG. 2 (a dotted line B) of this application.

According to the above conventional EGR valve device, however, the shaft is deeply inserted into the inside of the fluid passage and the valve body is manufactured by a cutting operation in order to achieve a higher accuracy of a valve dimension. Therefore, a thickness of the valve body is inevitably larger. As a result, an area of the fluid passage, which is occupied by the shaft and the valve body at a valve opened condition, may become larger to thereby increase pressure loss. Namely, it is disadvantage in that EGR amount according to the EGR valve device having the inclined valve body is smaller than the EGR amount of the EGR valve device having the valve body which is arranged at right angle with respect to the center line of the fluid passage.

As explained above, the valve body for the EGR valve device having the inclined valve is manufactured by the cutting operation. A cost for manufacturing the valve body (and thereby the FOR valve device itself) would become higher.

In the above EGR valve device having the inclined valve, a seal ring is provided at an outer periphery of the valve body for the purpose of sealing a gap between the outer periphery of the valve body and an inner peripheral surface of an EGR passage (the fluid passage). Due to a constrain (a bar) in a process of assembling the seal ring to the valve body, a C-shaped seal ring having a cut portion in its circumferential direction is used. It may be a disadvantage for such C-shaped seal ring in that a part of fluid (EGR gas) may leak through such cut portion even at the valve closed condition.

The EGR valve device is explained above as one of examples for the conventional valve devices. However, the above problems also exist in other valve devices, when such valve device has the inclined valve.

### SUMMARY OF THE INVENTION

The present invention is made in view of the above problems. It is an object of the present invention to provide a valve device, in which a shaft for a valve body is inclined with respect to a center line of a fluid passage and according to which pressure loss can be reduced at a valve opened condition.

According to a feature of the invention, a rotational axis of a shaft is inclined with respect to a center line of a fluid passage.

The shaft is composed of a first shaft member to which a driving force is applied and a second shaft member coaxially arranged with the first shaft member, wherein the first and second shaft members are separately arranged in the fluid passage.

A valve body is composed of a disc shaped valve member for closing the fluid passage, a first supporting portion provided at an outer peripheral portion of the disc shaped valve member and connected to the first shaft member, and a second supporting portion provided at another outer peripheral portion of the disc shaped valve member and connected to the second shaft member.

The above three components of the disc shaped valve member and the first and second supporting portions form a Z-shape when viewed in a direction parallel to a surface of the disc shaped valve member.

According to the above feature of the invention, there are following advantages:

(1) a ratio for a passage area of the fluid passage, which is occupied by the shaft, can be made smaller, and

(2) a ratio for a passage area of the fluid passage, which is occupied by the valve body, can be further made smaller, because the valve body is formed in such a way that the valve body forms the Z-shape in its cross-section.

According to the valve device of the invention, although the rotational axis of the shaft is inclined with respect to the center line of the fluid passage, the ratio for the passage area of the fluid passage (which is occupied by the shaft and the valve body) can be made smaller. Namely, pressure loss of the valve device can be suppressed to a smaller amount and a larger amount of fluid can flow at a valve fully-opened condition. Alternatively, the valve device can be made in a smaller size.

According to another feature of the invention, three components for the valve body, which has the disc shaped valve member and the first and second supporting portions, are formed of a press-molded metal plate.

As a result, the valve body can be made to become thinner, to thereby reduce the pressure loss in the valve opened condition.

When compared with a conventional valve body, which is made of a cutting operation, the valve body of the invention which is made of the press molding process can be manufactured in a lower cost. The cost for the valve device is accordingly decreased.

According to a further feature of the invention, a seal ring is provided at an outer periphery of the valve body and the seal ring is movable in a radial direction of the valve body.

As a result, the seal ring provided at the outer periphery of the valve body can absorb an accuracy decrease of a dimension for the valve body, which is manufactured by the press molding process. More exactly, an outer periphery of the seal ring slides on (and is thereby adjusted to) an inner peripheral surface of the fluid passage when the valve body is rotated to its valve closing position.

Therefore, it is possible to prevent a leakage of fluid at the valve closed condition, even in the case that the valve body is manufactured by the press molding process.

According to a still further feature of the invention, a seal ring provided at an outer periphery of the valve body (which is manufactured by the press molding process) is formed by an insert molding process.

As a result, a possible accuracy decrease of a dimension for the valve body, which may be caused during the press molding process, can be removed when the seal ring is formed by the insert molding process. More exactly, the seal ring is formed in such a manner that it could counterbalance accuracy error which is generated in the press-molded member, so that the outer periphery of the seal ring is adjusted to the inner peripheral surface of the fluid passage in the valve closed condition.

Therefore, it is possible to prevent a leakage of fluid at the valve closed condition, even in the case that the valve body is manufactured by the press molding process.

According to a still further feature of the invention, the valve body is formed by fixing a first and a second press-molded members to each other. The first press-molded member has the first supporting portion and the first disc shaped plate portion which forms one side surface of the disc shaped valve member. The second press-molded member has the second supporting portion and the second disc shaped plate portion which forms the other side surface of the disc shaped valve member.

As a result, the valve body can be made to become thinner, to thereby reduce the pressure loss in the valve fully-opened condition.

In addition, when compared with the conventional valve body, which is made of the cutting operation, the valve body of the invention which is made of the press molding process can be manufactured in a lower cost. The cost for the valve device is accordingly decreased.

According to a still further feature of the invention, the first and second press-molded members for the valve body are identical and fixed to each other, wherein first press-molded member is rotated by 180 degrees with respect the second press molded member.

As a result, the cost for manufacturing the valve body can be reduced.

According to a still further feature of the invention, the seal ring is interposed between outer peripheries of the first and second disc shaped plate portions, so that the seal ring is movable in a radial direction of the valve body.

According to a still further feature of the invention, the seal ring is formed of an O-shaped seal ring having no cut portion in its circumferential direction.

Since the seal ring is arranged in an annular groove formed between outer peripheries of the first and second disc shaped plate portions, the seal ring can be assembled to the valve body by interposing it between the first and second press-molded members. Therefore, the O-shaped seal ring having no cut portion in its circumferential direction can be used.

Then, a drawback of a C-shaped seal ring (gas may leak through a cut portion of the C-shaped seal ring) can be overcome by use of the O-shaped seal ring.

According to a still further feature of the invention, the seal ring is formed of a combination of an O-shaped seal ring having no cut portion in its circumferential direction, and a C-shaped seal ring having a cut portion in its circumferential direction.

Since the C-shaped seal ring has the cut portion in the circumferential direction, the C-shaped seal ring is easily adjusted to the inner peripheral surface of the fluid passage and thereby a diameter in the radial direction is changed. Therefore, the C-shaped seal ring can easily absorb diameter variations resulting from manufacturing errors and/or diameter changes due to thermal expansion, in such a manner that the outer periphery of the C-shaped seal ring is adjusted to the inner peripheral surface of the fluid passage. As a result, it is possible to prevent fluid from leaking through a gap between the disc shaped valve member and the fluid passage in the valve closed condition.

In addition, by the combination of the O-shaped and C-shaped seal rings, it is possible to prevent the gas from leaking through the cut portion of the C-shaped seal ring.

According to a still further feature of the invention, the seal ring is formed of a combination of two C-shaped seal rings, each of which has a cut portion in its circumferential direction.

As explained above, since the C-shaped seal ring has the cut portion in the circumferential direction, the C-shaped seal ring is easily adjusted to the inner peripheral surface of the fluid passage. And thereby, it is possible to prevent fluid from leaking through the gap between the disc shaped valve member and the fluid passage in the valve closed condition. When two of the C-shaped seal ring are combined together, the cut portion of one of the C-shaped seal rings is closed by the other C-shaped seal ring, and vice versa. As a result, each of the C-shaped seal rings prevents the EGR gas from leaking through the cut portion of the other C-shaped seal ring.

According to a still further feature of the invention, a punch-out opening formed in the first disc shaped plate portion is closed by the second disc shaped plate portion, and a punch-out opening formed in the second disc shaped plate portion is closed by the first disc shaped plate portion. The punch-out opening is formed in the first (or second) disc shaped plate portion, when a part of the first (or second) disc shaped plate portion is punched-out to form the first (or second) supporting portion.

Since the first and second disc shaped plate portions are fixed to each other and the punch-out opening of one disc shaped plate portions is closed by the other disc shaped plate portion, it is possible to prevent the gas from leaking through a gap between the first and second disc shaped plate portions.

According to a still further feature of the invention, an annular groove is formed between outer peripheries of the first and second disc shaped plate portions, and a first seal portion is formed between the annular groove and the seal ring arranged in the annular groove. A second seal portion is formed between the first and second disc shaped plate portions and at an area surrounding the punch-out opening. A third seal portion is further formed between the first and second disc shaped plate portions and at an area surrounding a locating hole. The first to third seal portions are made of silicon gel.

According to a still further feature of the invention, an intermediate plate member is interposed between the first and second disc shaped plate portions. A first seal portion is formed between the first and second disc shaped plate portions and at an outer periphery of the intermediate plate member. A second seal portion is formed between the first and second disc shaped plate portions and at a surrounding area for the punch-out opening. A third seal portion is formed between the first and second disc shaped plate portions and at a surrounding area for a locating hole. The first to third seal portions are made of sealing projections, which are formed in the intermediate plate member and flattened out between the first and second disc shaped plate portions.

According to a still further feature of the invention, the valve body is formed of the disc shaped valve member and the first and second supporting portions, which are made of a press-molded metal plate.

Since the three of the components for the valve body (the disc shaped valve member and the first and second supporting portions) are formed of one press-molded member, the valve body can be made thinner and thereby the pressure loss in the valve opened condition can be suppressed to a smaller amount.

In addition, since the valve body is made of the press-molded parts, the manufacturing cost can be decreased compared with that for the conventional valve body which is made by the cutting operation. The cost for manufacturing the valve device can be accordingly decreased.

According to a still further feature of the invention, a through-hole is formed at a center of the disc shaped valve member, so that a screw-driver may be inserted through the through-hole during an assembling process, and a cap member is attached to the disc shaped valve member for closing the through-hole.

According to a still further feature of the invention, the first supporting portion is rotated together with the first shaft member and the second supporting portion is rotated together with the second shaft member.

According to a still further feature of the invention, the first supporting portion is rotated together with the first shaft member and the second supporting portion is rotattably connected to the second shaft member.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic cross-sectional view showing an EGR valve device according to a first embodiment of the invention;

FIG. 2 is a graph showing a relationship between an opening area and a rotational angle of a shaft for a valve body of the EGR valve device;

FIG. 3A is a schematic cross-sectional view showing a valve body;

FIGS. 3B and 3C are schematic enlarged views showing a portion of the valve body;

FIG. 4A is a schematic exploded view of the valve body;

FIG. 48 is a schematic cross-sectional view showing the valve body in an assembled condition;

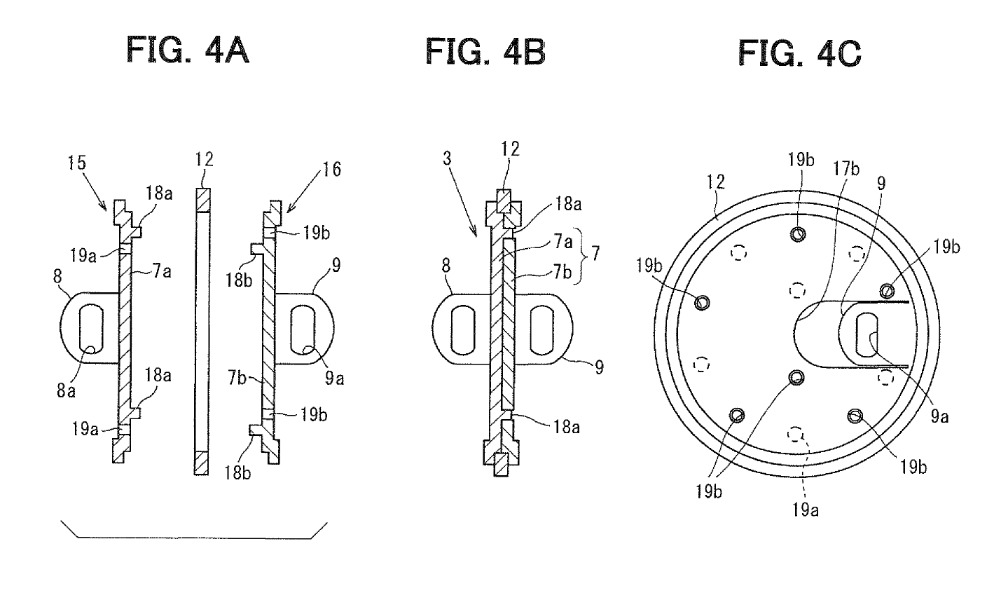

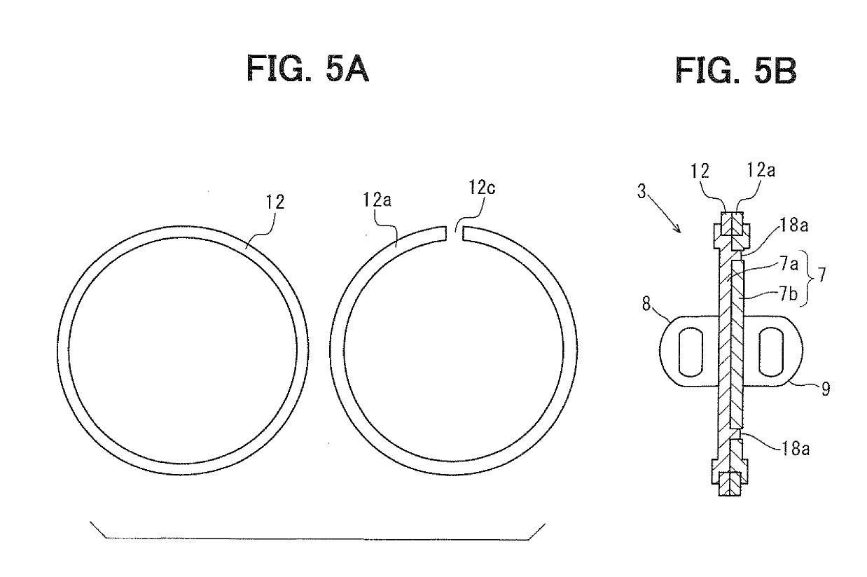

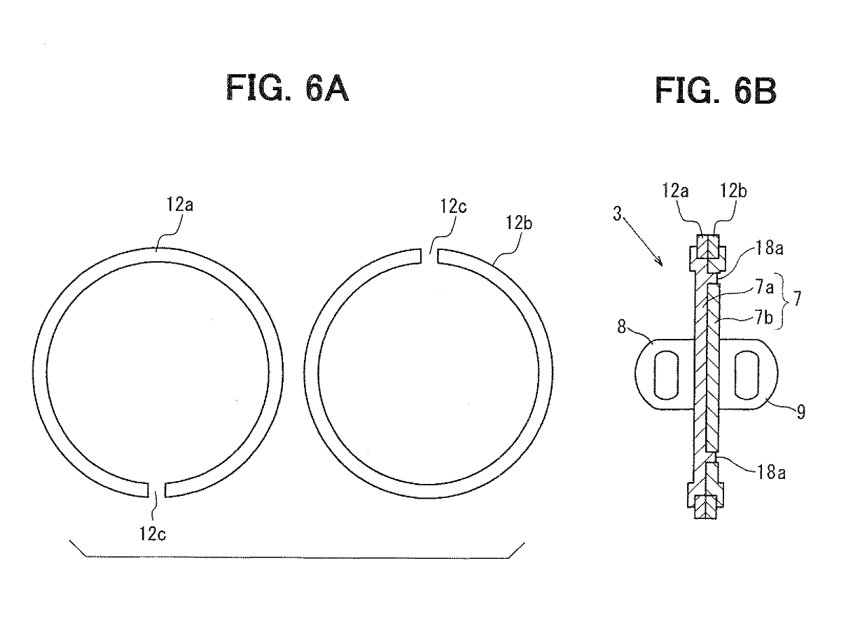

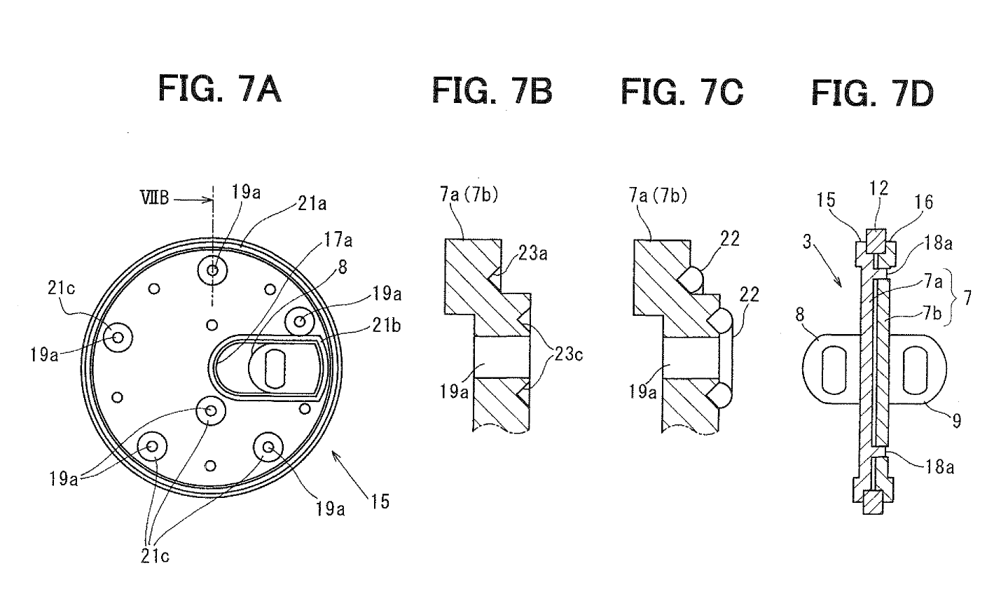

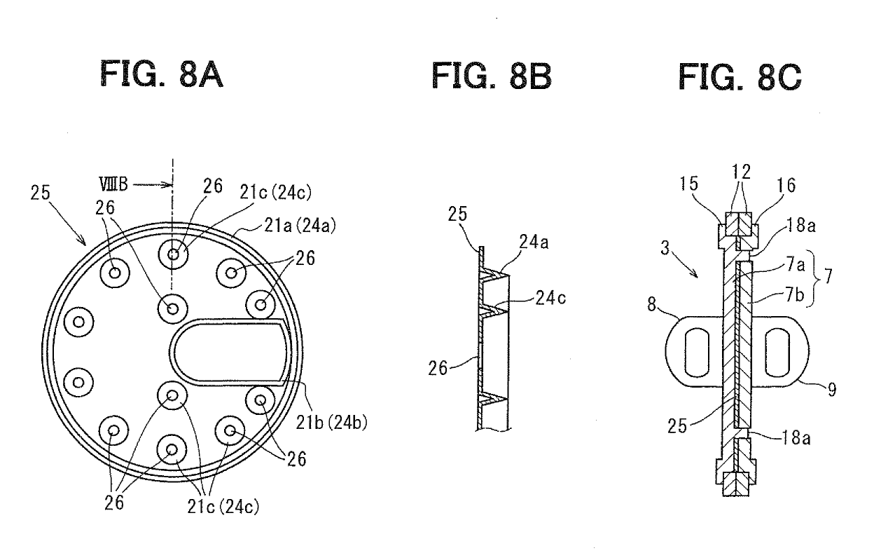

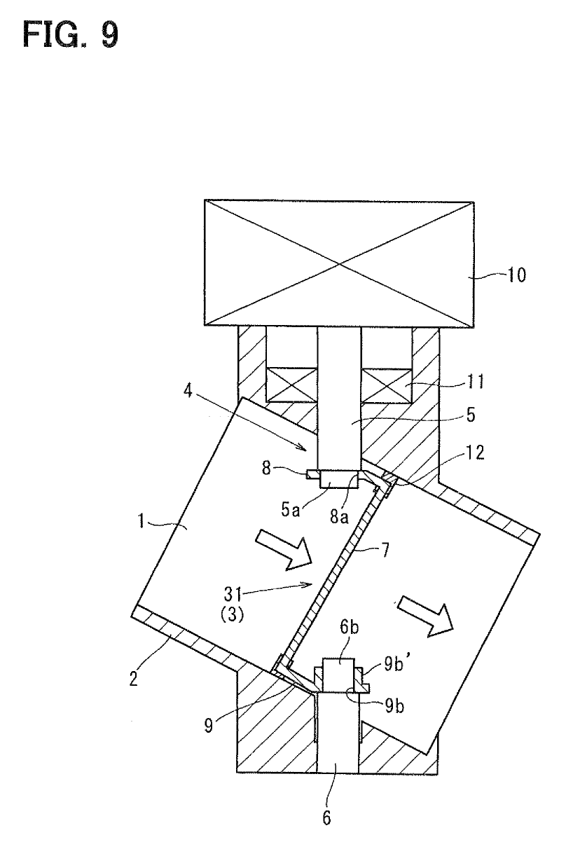

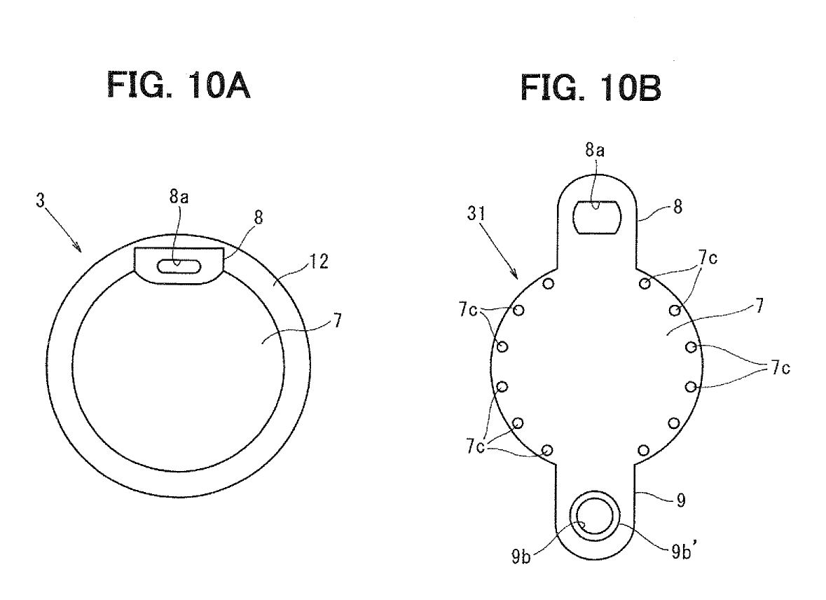

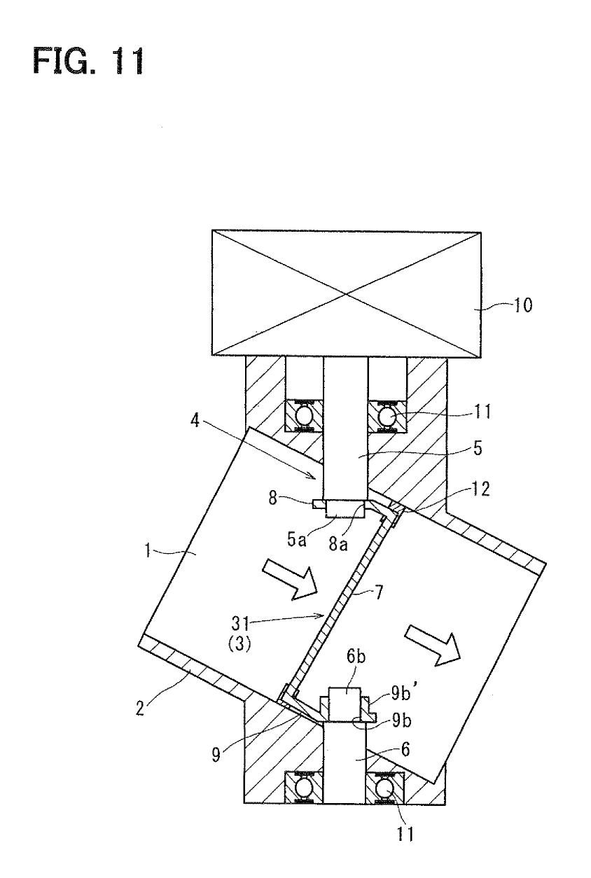

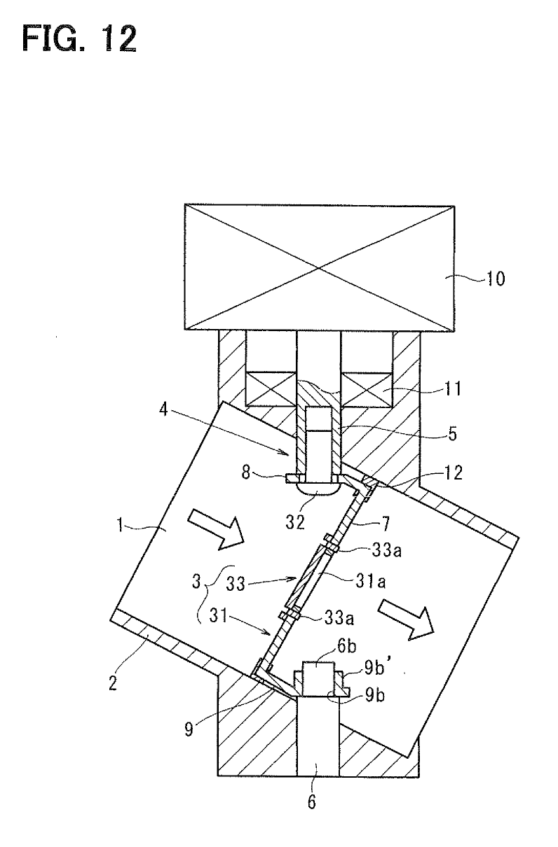

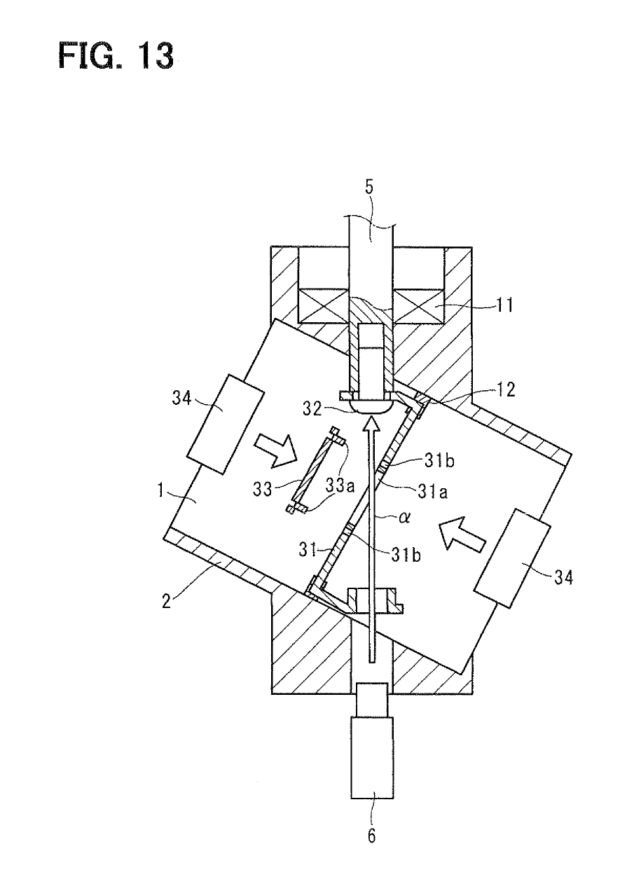

FIG. 4C is a schematic front view showing the valve body when viewed from a right-hand side in FIG. 48;

FIG. 5A is a schematic front view showing seal rings according to a second embodiment of the invention;

FIG. 5B is a schematic cross-sectional view showing the valve body in an assembled condition;

FIG. 6A is a schematic front view showing seal rings according to a third embodiment of the invention;

FIG. 6B is a schematic cross-sectional view showing the valve body in an assembled condition;

FIG. 7A is a front view showing a an inner surface of a valve member (one of press molded members) according to a fourth embodiment of the invention;

FIGS. 7B and 7C are schematic cross-sectional views taken along a line VIIB of FIG. 7A in an enlarged form;

FIG. 7D is a schematic cross-sectional view showing the valve body in an assembled condition;

FIG. 8A is a front view showing an intermediate plate member according to a fifth embodiment of the invention;

FIG. 8B is a schematic cross-sectional view taken along a line VIIIB of FIG. 8A in an enlarged form;

FIG. 8C is a schematic cross-sectional view showing the valve body in an assembled condition;

FIG. 9 is a schematic cross-sectional view showing an EGR valve device according to a sixth embodiment of the invention;

FIG. 10A is a schematic front view showing a valve body to which a seal ring is attached;

FIG. 10B is a schematic extended view showing a main press-molded member;

FIG. 11 is a schematic cross-sectional view showing an EGR valve device according to a seventh embodiment of the invention;

FIG. 12 is a schematic cross-sectional view showing an EGR valve device according to an eighth embodiment of the invention; and

FIG. 13 is a schematic cross-sectional view for explaining an assembling process of the EGR valve device.

### DETAILED DESCRIPTION OF THE PREFERRED EMBODIMENTS

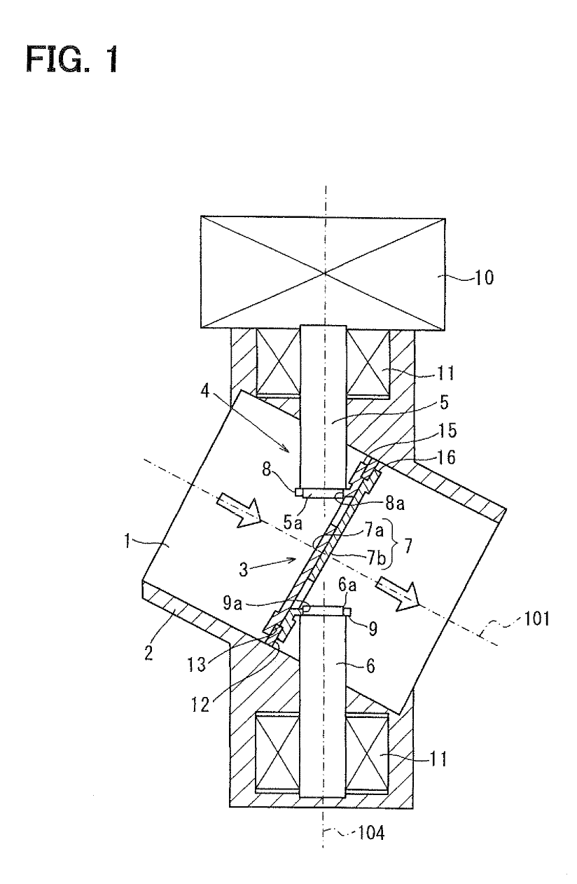

Embodiments of the present invention will be explained with reference to FIGS. 1 to 13.

An EGR valve device (an example of a valve device) is composed of a housing 2 having a part of an EGR passage 1 which connects an exhaust passage and an intake air passage of an engine so as to re-circulate a part of exhaust gas into the intake air passage, a valve body 3 rotatably arranged in the EGR passage 1 for controlling an opening degree of the EGR passage 1 (an opening area of the passage) with a rotational movement thereof in the EGR passage 1, and a shaft 4 rotatably supported by the housing 2 for driving the valve body 3, wherein a rotational axis 104 of the shaft 4 is inclined with respect to a center line 101 of the EGR passage 1. In other words, the EGR valve device is of a type, in which valve body 3 is inclined with respect to the EGR passage 1.

The shaft 4 of the EGR valve device is composed of a first shaft member 5 which receives a driving force from an outside and a second shaft member 6 which is co-axially arranged with the first shaft member 5, wherein the first and second shaft members 5 and 6 are separately arranged in the EGR passage 1 from each other.

The valve body 3 of the EGR valve device is composed of a disc shaped valve member 7 for opening and closing the EGR passage 1, a first supporting portion 8 provided at an outer periphery of the valve member 7 for connecting the valve member 7 to the first shaft member 5, and a second supporting portion 9 provided at the outer periphery of the valve member 7 but at an opposite side to the first supporting valve 8 for connecting the valve member 7 to the second shaft member 6. The valve member 7, the first supporting portion 8 and the second supporting portion 9 form a shape of a letter Z in the cross section, when viewed in a direction parallel to a surface of the valve member 7, as shown in FIG. 1.

### First Embodiment

A first embodiment will be explained with reference to FIGS. 1 to 4, wherein the present invention is applied to the EGR valve device installed in the engine for a vehicle. The same reference numerals are used for identical or similar parts through multiple embodiments.

According to the EGR valve device, a part of exhaust gas emitted from the engine is re-circulated into an intake air passage of the engine in order to suppress an increase of combustion temperature by mixing air-fuel mixture with the re-circulated exhaust gas as a non-combustible gas. As a result, generation of nitrogen oxides (NOx) is effectively suppressed.

The EGR valve device has the EGR passage 1 for re-circulating the part of the exhaust gas from an exhaust passage into the intake air passage and the EGR valve body 3 for controlling an opening degree of the EGR passage 1. The EGR valve body 3 is driven by an actuator which is operated by an ECU (Engine Control Unit) depending on an operating condition of the vehicle.

The EGR valve device of the present invention may be applied to a high pressure EGR apparatus, according to which the part of the exhaust gas is re-circulated into a portion of the intake air passage (a downstream side of a throttle valve) where a large negative pressure is generated, or may be applied to a low pressure EGR apparatus, according to which the part of the exhaust gas is re-circulated into a portion of the intake air passage (an upstream side of the throttle valve, for example an upstream side of a compressor in case of a vehicle having a turbo charger) where a small negative pressure is generated.

The EGR valve device will be explained more in detail with reference to FIG. 1. Only for the purpose of explaining the embodiment, words of “upper” or “lower” are used to designate an upper or a lower side in the drawing. The invention should not be limited to such directions explained hereinafter.

As already explained above, the EGR valve device has the housing 2 forming the part of the intake air passage 1 in its inside, the EGR valve body 3 arranged in the EGR passage 1, the shaft 4 for supporting the valve body 3, and an electric actuator 10 for applying the driving force to the shaft 4 from the outside.

A main portion of the housing 2 is made of aluminum base alloy manufactured by a die casting method. An inner surface portion of the housing 2, through which high temperature EGR gas passes, is made of material, such as stainless steel, which is higher in heat resistance and corrosion resistance.

The valve body 3 is a butterfly type valve which is capable of not only opening and closing the EGR passage 1 but also controlling an opening degree (an opening area) of the EGR passage 1 depending on a rotational position of the shaft 4, so that EGR amount of the exhaust gas to be re-circulated into the intake air passage is controlled by adjusting the opening area of the EGR passage 1. The detailed explanation for the valve body 3 will be made below.

The shaft 4 rotatably supports the valve body 3 in the EGR passage 1, wherein the first and second shaft members 5 and 6 are respectively and rotatably supported by bearings 11, which are arranged at an upper and a lower side of the housing 2. A shield type bearing is used for the bearings 11 in order to prevent leakage of the EGR gas.

The upper and lower bearings 11 are composed of rolling-type bearings, such as ball bearings, roller bearings and so on, or sliding-type bearings, such as metal bearings and so on. Each of the bearings 11 is fixed to the housing 2 by a press-fitting, for example, by press inserting the bearings into accommodating cylindrical holes formed in the housing 2, so that the bearings 11 rotatably support the shaft 4, which is press inserted into an inner periphery of the bearings 11.

The electric actuator 10 is provided at an upper portion of the housing 2 for driving the shaft 4 to rotate. The electric actuator 10 is composed of a well-known electric motor which generates a rotational driving force upon receiving electric power. A DC motor, for which a control of rotational angle is possible by electric power supply, is used in this embodiment as an example of the electric motor.

The electric actuator 10 may be composed of solely the electric motor (namely, the shaft 4 may be directly driven by the electric motor), or may be composed of the electric motor and a speed reduction mechanism provided between the electric motor and the shaft 4 (for example, a mechanical reduction gear, so that rotational speed of the electric motor is reduced and such increased torque as a result of the speed reduction is transmitted to the shaft 4.

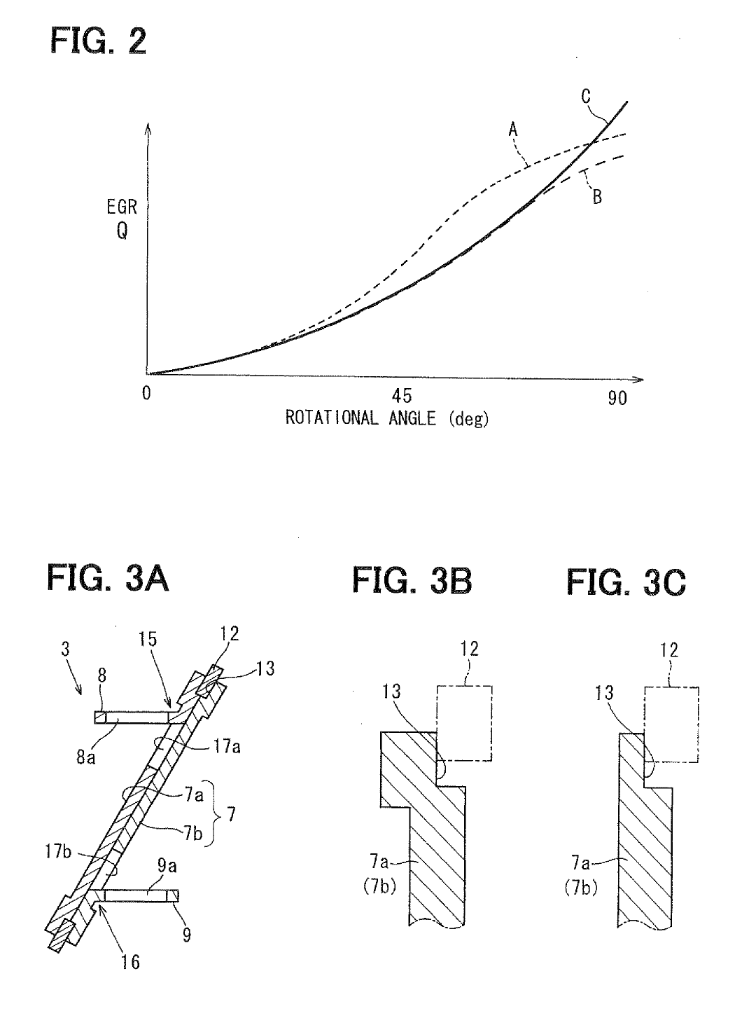

As shown in FIG. 1, according to the EGR valve device of the first embodiment, the rotational axis 104 of the shaft 4 for driving the valve body 3 is inclined with respect to the center line 101 of the EGR passage 1. As already explained, in the case of the valve device having the inclined valve body, the shaft 4 is deeply inserted into the inside of the EGR passage 1. In addition, when the valve body is manufactured by the cutting operation, the thickness of the valve body becomes larger. As a result, according to the conventional EGR valve device, an area of the EGR passage 1 occupied by the shaft 4 and the valve body 3 would become larger at the valve opened condition. And therefore it may have a disadvantage in that the EGR amount would be decreased at the valve opened condition due to an increase of air-flow resistance (as shown by the dotted line B in FIG. 2).

The invention of the first embodiment has the following structure in order to overcome the above disadvantage.

As already explained, the shaft 4 for supporting the valve body 3 is composed of the first shaft member 5 which receives the driving force from the electric actuator 10 arranged at the upper portion of the housing 2 and the second shaft member 6 which is co-axially arranged with the first shaft member 5, wherein the first and second shaft members 5 and 6 are separately arranged in the EGR passage 1 from each other, as shown in FIG. 1.

The first shaft member 5 is made of such material which is superior in heat resistance and corrosion resistance (for example, stainless steel), formed in a column-shape, and arranged in the upper portion of the housing 2. The first shaft member 5 is extending in a vertical direction and rotatably supported by the bearing 11 provided in the housing 2. At a lower end of the first shaft member 5, a first width-across-flat portion 5a is formed as a link portion, which is connected to an upper portion of the valve body 3 (more exactly, a first supporting portion 8 explained below), so that the valve body 3 is rotated together with the first shaft member 5.

The second shaft member 6 is likewise made of such material which is superior in heat resistance and corrosion resistance (for example, stainless steel), formed in a column-shape, and arranged in the lower portion of the housing 2. The second shaft member 6 is extending in the vertical direction and rotatably supported by the bearing 11 provided in the housing 2. In the same manner to the first shaft member 5, at an upper end of the second shaft member 6, a second width-across-flat portion 6a is formed as a link portion, which is connected to a lower portion of the valve body 3 (more exactly, a second supporting portion 9 explained below), so that the valve body 3 is rotated, together with the second shaft member 6.

The valve body 3 is provided between the first and second shaft members 5 and 6, and the valve body 3 is composed of the disc shaped valve member 7 for opening and closing the EGR passage 1, the first supporting portion 8 formed at the upper portion of the valve member 7 and connected to the lower end of the first shaft member 5, and the second supporting portion 9 formed at the lower portion of the valve member 7 and connected to the upper end of the second shaft member 6. As explained above, the valve member 7, the first supporting portion 8 and the second supporting portion 9 form the shape of the letter Z in the cross section (when viewed in the direction parallel to the surface of the valve member 7), as shown in FIG. 1.

The disc shaped valve member 7 has an outer diameter, which is slightly smaller than an inner diameter of the EGR passage 1 of a cylindrical shape, and a small thickness. When the valve member 7 is rotated to a position, at which the valve member 7 is perpendicular to the center liner 101 of the EGR passage 1, as shown in FIG. 1, the EGR passage 1 is fully closed by the valve member 7. A seal ring 12 is provided at an outer periphery of the disc shaped valve member 7, so as to seal a gap between an inner peripheral surface of the EGR passage 1 and the outer periphery of the valve member 7. An annular groove 13 is formed at the outer periphery of the valve member 7 so that the seal ring 12 is assembled in the groove 13.

The first supporting portion 8 is formed at the upper portion of the valve member 7 (more exactly, on a surface of the valve member 7 directed toward an upstream side of the EGR passage 1 in a valve closed condition) and connected to the lower end of the first shaft member 5, so that the valve member 7 is rotated together with the first shaft member 5. The first supporting portion 8 is made of a thin plate material as in the same manner to the valve member 7. In a condition that the first supporting portion 8 is connected to the lower end of the first shaft member 5, the first supporting portion 8 is perpendicular to the rotational axis of the first shaft member 5. A first connecting hole 8a (having a shape similar to an oval) is formed at the first supporting portion 8 as a link portion, into which the first width-across-flat portion 5a of the first shaft member 5 is inserted so that the valve member 7 is rotated together with the first shaft member 5.

In a similar manner to the first supporting portion 8, the second supporting portion 9 is formed at the lower portion of the valve member 7 (more exactly, on a surface of the valve member 7 directed toward a downstream side of the EGR passage 1 in the valve closed condition) and connected to the upper end of the second shaft member 6, so that the valve member 7 is rotated together with the second shaft member 6. The second supporting portion 9 is made of the thin plate material as in the same manner to the valve member 7. In a condition that the second supporting portion 9 is connected to the upper end of the second shaft member 6, the second supporting portion 9 is perpendicular to the rotational axis of the second shaft member 6. A second connecting hole 9a (having a shape similar to an oval) is also formed at the second supporting portion 9 as the link portion, into which the second width-across-flat portion 6a of the second shaft member 6 is inserted so that the valve member 7 is rotated together with the second shaft member 6.

The first width-across-flat portion 5a and first connecting hole 8a as well as the second width-across-flat portion 6a and second connecting hole 9a are firmly fixed to each other by welding after the each of the width-across-flat portions is inserted (press inserted or loosely inserted) into the respective connecting holes 8a and 9a.

The above first embodiment has the following advantages (when the valve body 3 is at its fully-opened position or at a position close to such position):

(1) a ratio of the passage area of the EGR passage 1, which is occupied by the shaft 4 is made smaller, because the shaft 4 is divided into two shaft members 5 and 6; and
(2) the ratio of the passage area of the EGR passage 1, which is occupied by the valve member 7 and the first and second supporting portions 8 and 9, can be further made smaller. This is because the valve member 7 as well as the first and second supporting portions 8 and 9 is made of the plate material having thin thickness.

According to the above advantages, the air-flow resistance at the valve fully-opened position can be made smaller and thereby pressure loss at the EGR valve device can be likewise made smaller when the valve body is at its fully-opened position.

According to the first embodiment, the opening degree (the opening area) of the EGR passage 1 is changed in accordance with the rotational angle of the shaft 4, as indicated by a solid line C in FIG. 2.

As above, although the EGR device of the first embodiment is such a type, in which the valve body is arranged in an inclined position with respect to the center line of the EGR passage, the opening area of the EGR passage can be made larger when the valve body is moved to its fully-opened position. As a result, a larger amount of the EGR gas can be re-circulated and the pressure loss at the EGR valve device can be made smaller. Alternatively, the EGR valve device can be made smaller, as a result that the opening area of the EGR passage can be made larger in the valve fully-opened condition.

As already explained above, the rotational axis 104 of the shaft 4 (the first and second shaft members 5 and 6) is inclined with respect to the center line 101 of the EGR passage 1.

According to the conventional EGR valve device, the valve body 3 is made of the cutting operation when the valve body is arranged in the inclined condition. Therefore, the valve body is higher in cost, resulting in the higher cost of the EGR valve device.

The invention of the first embodiment, however, has the following structure and manufacturing method in order to overcome the above problem.

The valve body 3 is composed of a first press-molded member 15 and a second press-molded member 16, which are made of a thin metal plate (for example, a thin stainless steel plate), and which are fixed together to each other, as shown in FIG. 3A or FIGS. 4A to 4C.

The first press-molded member 15 has a first disc shaped plate portion 7a which forms one side surface of the disc shaped valve member 7, and the first supporting portion 8 which is formed by punching out a portion of the first disc shaped plate portion 7a.

In a similar manner, the second press-molded member 16 has a second disc shaped plate portion 7b which forms the other side surface of the disc shaped valve member 7, and the second supporting portion 9 which is formed by punching out a portion of the second disc shaped plate portion 7b.

The above first and second press-molded members 15 and 16 are parts identical to each other. The valve body 3 is formed by two of the same parts, wherein one of the parts is rotated by 180 degrees and fixed to the other.

A punch-out opening 17a is formed in the first disc shaped plate portion 7a as a result of forming the first supporting portion 8, and a punch-out opening 17b is likewise formed in the second disc shaped plate portion 7b as a result of forming the second supporting portion 9.

Locating projections 18a and locating holes 19a are formed at the first disc shaped plate portion 7a. Similarly, the locating projections 18b and locating holes 19b are formed at the second disc shaped plate portion 7b, so that each of the locating projections 18a and 18b is inserted into each of the locating holes 19a and 19b when the first and second disc shaped plate portions 7a and 7b are fixed to each other.

The locating projections 18a and 18b and the locating holes 19a and 19b of the disc shaped plate portions 7a and 7b are firmly fixed by, for example, the welding method, after the first and second disc shaped plate portions 7a and 7b are assembled together.

The punch-out opening 17a as well as the locating holes 19a of the first disc shaped plate portion 7a is closed by the second disc shaped plate portion 7b. The punch-out opening 17b as well as the locating holes 19b of the second disc shaped plate portion 7b is likewise closed by the first disc shaped plate portion 7a. As a result, the EGR gas may not pass though any inside portion of the valve body 3, which is formed by the first and second disc shaped plate portions 7a and 7b.

According to the above first embodiment, since the valve body 3 is formed by fixing the first and second press-molded members 15 and 16, the valve body 3 can be made as a thin body so that the EGR valve device has a smaller pressure loss.

In addition, since the valve body is made of the press-molded parts, the manufacturing cost can be decreased compared with that for the conventional valve body which is made by the cutting operation. In particular, according to the first embodiment, since the first and second press-molded members 15 and 16 are made as the same parts, the manufacturing cost for the valve body 3 can be made lower.

In the case that the valve body 3 is formed by fixing the first and second press-molded members 15 and 16, accuracy of dimension may be decreased compared with the conventional valve body which is made by the cutting operation. The seal ring 12 is provided at the outer periphery of the disc shaped valve member 7 so as to overcome the above drawback, namely to absorb a possible decrease of the accuracy of dimension.

More exactly, the disc shaped valve member 7 movably supports the seal ring 12 at the outer periphery thereof in a radial direction. As a result, an outer peripheral portion of the seal ring 12 smoothly moves (slides) on an inner peripheral surface of the EGR passage 1, when the valve body 3 is moved (rotated) in a valve closing direction (or in a valve opening direction), so that the decrease of accuracy of dimension can be absorbed by the movement of the seal ring 12 in the radial direction.

In case of the valve body made of the cutting operation, a C-shaped seal ring having a cut portion (discontinuity) is generally used, because there is a bar in assembling the seal ring to the valve body. As a result, the EGR gas may leak through the cut portion of the C-shaped seal ring even when the valve body is moved to its fully-closed position.

According to the above first embodiment, however, the annular groove 13 is formed at the outer periphery of the valve member 7 so that the seal ring 12 is inserted into the groove 13.

The annular groove 13 is formed between an outer peripheral end of the first disc shaped plate portion 7a and an outer peripheral end of the second disc shaped plate portion 7b, as shown in FIG. 3A. A stepped portion for forming the annular groove 13 at the outer peripheral end of the first and second plate portions 7a and 7b may be made by a press working, for example by a bending process as shown in FIG. 3B or by a rolling process as shown in FIG. 3C.

According to the first embodiment, an O-shaped seal ring (having no cut portion in a circumferential direction) is used as the seal ring 12.

Since the seal ring 12 is interposed in the annular groove 13 formed between the outer peripheral ends of the first and second disc shaped plate portions 7a and 7b, as shown in FIGS. 4A and 4B, the seal ring 12 is sandwiched in the annular groove 13 by the first and second press-molded members 15 and 16. Therefore, the seal ring of the O-shape having no cut portion in the circumferential direction can be used.

As a result, the drawback of the C-shaped seal ring (the EGR gas may leak through the cut portion of the C-shaped seal ring) can be overcome.

### Second Embodiment

A second embodiment will be explained with reference to FIGS. 5A and 5B. The same reference numerals to the first embodiment are used for identical or similar parts in the second embodiment.

According to the above first embodiment, one O-shaped seal ring 12 having no cut portion is used.

According to the second embodiment, as shown in FIG. 5A, one C-shaped seal ring 12a having a cut portion 12c in its circumferential direction is used in addition to one O-shaped seal ring 12 having no cut portion.

Since the C-shaped seal ring 12a has the cut portion 12c in the circumferential direction, it is much easier that an outer peripheral portion thereof may be adjusted to the inner peripheral surface of the EGR passage 1. In other words, an outer diameter of the C-shaped seal ring 12a is easily changed to seal the gap between the outer periphery of the seal ring 12a and the inner peripheral surface of the EGR passage 1. Therefore, the C-shaped seal ring 12a can easily absorb diameter variations resulting from manufacturing errors and/or diameter changes due to thermal expansion, because the outer periphery of the C-shaped seal ring is easily adjusted to the inner peripheral surface of the EGR passage 1. As a result, it is possible to avoid such an unfavorable situation in which a part of the EGR gas may leak through any gap between the disc shaped valve member 7 and the EGR passage 1 when the valve member 7 is in the valve closed condition.

In addition, by the combination of the O-shaped and C-shaped seal rings 12 and 12a, it is possible to prevent the EGR gas from leaking through the cut portion 12c of the C-shaped seal ring 12a.

As above, according to the second embodiment, it is possible to avoid a disadvantage of the C-shaped seal ring (that is, the EGR gas may leak through the cut portion of the C-shaped seal ring when the EGR valve is at its fully-closed position), and at the same time it is possible to obtain an advantage of the C-shaped seal ring 12a (that is, the outer periphery of the C-shaped seal ring 12a may be easily adjusted to the inner peripheral surface of the EGR passage 1 so that the EGR gas is prevented from leaking through the gap between the valve member 7 and the EGR passage 1 when the valve member 7 is at the fully-closed position.

### Third Embodiment

A third embodiment will be explained with reference to FIGS. 6A and 6B.

According to the third embodiment, as shown in FIG. 6A, two C-shaped seal rings 12a and 12b are used in combination with each other.

As explained above, according to the above second embodiment, the outer periphery of the C-shaped seal ring 12a (12b) may be easily adjusted to the inner peripheral surface of the EGR passage 1 when the valve member 7 is at the fully-closed position, because it has the cut portion 12c in the circumferential direction. As a result, the EGR gas is prevented from leaking through the gap between the valve member 7 and the EGR passage 1.

According to the third embodiment, two of the C-shaped seal ring 12a and 12b are combined together, so that the cut portion 12c of one of the C-shaped seal rings is closed by the other C-shaped seal ring, and vice versa. As a result, each of the C-shaped seal rings 12a and 12b prevents the EGR gas from leaking through the cut portion 12c of the other C-shaped seal ring. In addition, it is likewise possible to obtain the advantage of the C-shaped seal ring (that is, the outer periphery of the C-shaped seal ring may be easily adjusted to the inner peripheral surface of the EGR passage 1 so that the EGR gas is prevented from leaking through the gap between the valve member 7 and the EGR passage 1 when the valve member 7 is at the fully-closed position).

### Fourth Embodiment

A fourth embodiment will be explained with reference to FIGS. 7A to 7D.

According to the fourth embodiment, a first seal portion 21a is formed at the step portion for forming the annular groove 13, namely on each of the inner surfaces opposing to each other in the annular groove 13. A second and third seal portions 21b and 21c are formed at respective surrounding areas for the punch-out opening 17a (17b) and the locating holes 19a (19b) on each of the inner surfaces of the first and second press-molded members 15 and 16, as shown in FIG. 7A. The seal portions 21a to 21c are formed of silicon gel 22. The silicon gel 22 allows the movement of the seal ring 12 in the radial direction. In other words, the silicon gel 22 moves along with the seal ring 12 in the radial direction to achieve a sealing effect. A change of dimension may not generally occur in the silicon gel 22 due to creep or the like.

More exactly, as shown in FIGS. 7A and 7B, a first sealing groove 23a is formed on the inner surface of each of (or either one of) the disc shaped plate portions 7a and 7b and at the step portion. A second sealing groove 23b is formed on the inner surface of the first disc shaped plate portion 7a and at a surrounding area for the punch-out opening 17a. And third sealing grooves 23c are formed on the inner surface of the first disc shaped plate portion 7a and at surrounding areas for the locating holes 19a. The first to third sealing grooves 23a to 23c are filled with the silicon gel 22, as shown in FIGS. 7A and 7C. The sealing grooves 23a to 23c may be formed at the press working process for manufacturing the press-molded members 15 and 16.

After the sealing grooves 23a to 23c are filled with the silicon gel 22 as shown in FIG. 7C, the first and second disc shaped plate portions 7a and 7b are overlapped with each other as shown in FIG. 7D in such a manner that the seal ring 12 is interposed between them. As a result, the seal portions made of the silicon gel 22 are formed at the surrounding areas for the punch-out opening 17a (17b) and the locating holes 19a (19b) between the first and second disc shaped plate portions 7a and 7b. At the same time, the seal portion 21a made of the silicon gel 22 is likewise formed at the step portion so as to seal the gap between the annular groove 13 and the seal ring 12.

### Fifth Embodiment

A fifth embodiment will be explained with reference to FIGS. 8A to 8C.

According to the fifth embodiment, first to third seal portions 21a to 21c are made of sealing projections 24a to 24c, which are flattened out between the first and second disc shaped plate portions 7a and 7b when they are overlapped with each other.

More exactly, the first to third sealing projections 24a to 24c are formed at an intermediate plate member 25, which is interposed between the first and second disc shaped plate portions 7a and 7b. The intermediate plate member 25 is made of a sealing plate of a thin film, which is, for example, manufactured of heat-resisting resin film. The first sealing projection 24a is formed at an outer periphery of the intermediate plate member 25. The second sealing projection 24b is formed at a surrounding area for the punch-out opening 17a. The third sealing projections 24c are formed at surrounding areas for the locating projections 18a and the locating holes 19a. Although not shown in FIG. 8A, a fourth sealing projection may be formed on the intermediate plate member 25 and at a surrounding area for the punch-out opening 17b. Numeral 26 designates apertures formed in the intermediate plate member 25 at the locating projections 18a and the locating holes 19a.

As shown in FIG. 8C, the intermediate plate member 25 is interposed between the first and second disc shaped plate portions 7a and 7b. When the locating projections 18a and 18b are inserted into the respective locating holes 19a and 19b and the first and second disc shaped plate portions 7a and 7b are firmly fixed to each other (pressed against each other), the sealing projections 24a to 24c are flattened out between (and in a thickness direction of) the first and second disc shaped plate portions 7a and 7b. As a result, the first to third seal portions 21a to 21c are formed from the sealing projections 24a to 24c.

### Sixth Embodiment

A sixth embodiment will be explained with reference to FIGS. 9, 10A and 10B.

According to the above embodiments, the two (the first and second) press-molded members 15 and 16 are fixed to each other, to thereby form the valve body 3 having the disc shaped valve member 7 and the first and second supporting portions 8 and 9.

According to the sixth embodiment, one press-molded member 31 is formed as the valve body 3 having respective portions corresponding to the disc shaped valve member 7 and the first and second supporting portions 8 and 9, as shown in FIG. 10B.

As a number of parts for forming the valve body 3 is reduced, the cost for the EGR valve device can be correspondingly reduced.

According to the above first to fifth embodiments, the second supporting portion 9 is connected to the second shaft member 6, so that they are rotated together.

According to the sixth embodiment, the second supporting portion 9 is rotatably connected to the second shaft member 6. More exactly, the second shaft member 6 is firmly fixed (press inserted) to the housing 2, and the second supporting portion 9 is rotatably supported by the upper end of the second shaft member 6.

Accordingly, the bearing 11 for rotatably supporting the second shaft member 6 (for example, as shown in FIG. 1) can be eliminated in this sixth embodiment. The cost for the EGR valve device can be thus reduced. Since the second shaft member 6 is press inserted into the housing 2, it is possible to prevent the EGR gas from leaking from a gap between the second shaft member 6 and the housing 2. A reliability of the EGR valve device can be increased.

An example for rotatably connecting the second supporting portion 9 to the second shaft member 6 will be explained. A small diameter portion 6b of a column shape is formed at the upper end of the second shaft member 6. A shaft supporting hole 9b is formed at the second supporting portion 9, so that the small diameter portion 6b is rotatably inserted into the shaft supporting hole 9b. More exactly, a cylindrical wall portion 9b′ is formed at the shaft supporting hole 9b by a burring process. An inner diameter of the cylindrical wall portion 9b′ (that is, an inner diameter of the shaft supporting hole 9b) is made to be slightly larger than an outer diameter of the small diameter portion 6b by a sliding clearance.

Since the cylindrical wall portion 9b′ is formed, it is possible to increase a contact area between the second shaft member 6 and the second supporting portion 9. As a result, a wear of contacting portions, which would be caused by the operation of the EGR valve device, between the second shaft member 6 and the second supporting portion 9 can be suppressed. A reliability of the EGR valve device can be increased in this respect, too.

According to the above first to fifth embodiments, the seal ring 12 is movable in the radial direction at the outer periphery of the disc shaped valve member 7 so that the seal ring 12 may absorb (compensate) a decrease of dimensional accuracy of the valve body 3 when it is made of the press-molded members.

According to the sixth embodiment, the seal ring 12 is formed at the disc shaped valve member 7 by an insert molding process, so that a possible decrease of the dimensional accuracy for the valve body 3 made of the press-molded member is eliminated. In other words, the seal ring 12 is formed so as to eliminate dimensional errors of the valve body which would be generated in the press-molded member. As a result, an outer periphery of the seal ring 12 can be positioned (can be in contact) in a good condition with respect to the inner peripheral surface of the EGR passage 1, when the valve body 3 is moved to the valve closing position.

Accordingly, it is possible to prevent the EGR gas from leaking through the gap between the valve body and the inner peripheral surface of the EGR passage when the valve body is in the valve closing position, even in the case that the valve body 3 is made of the press-molded member.

The seal ring 12 of this embodiment is made of the heat resisting resin. As shown in FIG. 10A, the seal ring 12 is formed at the outer periphery of the disc shaped valve member 7 (surrounding the whole outer periphery). As shown in FIG. 10B, a plurality of holes 7c are formed on one or both sides of the press-molded member 7 at an outer peripheral portion, so that a part of the resin for the seal ring 12 is pushed into the holes 7c during the insert molding process and thereby binding force between the seal ring 12 made of the resin and the disc shaped valve member 7 made of the press-molded member is increased. As a result, the seal ring 12 may not be separated from the disc shaped valve member 7 for a long period.

### Seventh Embodiment

A seventh embodiment will be explained with reference to FIG. 11.

According to the above sixth embodiment, the second shaft member 6 is fixed to the housing 2. According to the seventh embodiment, however, the second shaft member 6 is rotatably supported by the housing 2 by means of a bearing 11 having a sealing function.

As a result that the second supporting portion 9 is rotatably supported by the second shaft member 6 at two rotatable portions, rotating resistance for the second supporting portion 9 can be decreased. Then, a driving load for the electric actuator 10 for the EGR valve device can be decreased.

### Eighth Embodiment

An eighth embodiment will be explained with reference to FIGS. 12 and 13.

According to the above first to seventh embodiments, the first supporting portion 8 is fixed to the first shaft member 5 by the welding process. According to the eighth embodiment, however, the first supporting portion 8 is fixed to the first shaft member 5 by a screw 32.

The screw 32, which is fastened to the first shaft member 5 to fix the first supporting portion 8 thereto, is operated by a screw driver (a machine tool: an excursion of the screw driver being inserted is shown by an arrow “α” in FIG. 13). The screw driver is inserted through a shaft assembling opening of the housing 2, which is also a hole into which the second shaft member 6 is afterwards inserted and fixed.

A through-hole 31a is formed in a center of the valve member 7, so that the screwdriver may be inserted through such through-hole during the assembling process.

The through-hole 31a is closed by a cap member 33, which is attached to the valve member 7, after the screw 32 is fastened to the first shaft member 5. The cap member 33 may be also made by the press molding process. A plurality of projections 33a is formed at an outer periphery of the cap member 33. A plurality of holes 31b is formed in the valve member 7 at an outer periphery of the through-hole 31a. The plurality of projections 33a is inserted into (press fitted) the respective holes 31b.

When assembling the valve body 3 in the housing 2, the valve member 7 is fixed to the first shaft member 5 by fastening the screw 32 with the screwdriver. Then, the small diameter portion 6b formed at the upper end of the second shaft member 6 is inserted into the shaft supporting hole 9b of the second supporting portion 9 and at the same time the second shaft member 6 is press inserted into the housing 2 (the shaft assembling opening formed in the housing 2). Then, as shown in FIG. 13, the cap member 33 and the valve member 7 are pressed against each other by a jig 34, so that the projections 33a are press inserted into the holes 31b to thereby close the through-hole 31a.

As above, the first supporting portion 8 may be fixed to the first shaft member 5 by means of the welding method as explained in the above first embodiment, or alternatively by the screw 32 as explained in the above eighth embodiment. In addition, any other fixing method can be applied to fix the valve member to the shaft member.

According to the above embodiments, the valve device of the invention is applied to the EGR valve device. Fluid, flow amount of which is controlled by the valve device, may not be limited to the exhaust gas. The valve device of the invention may be applied to any other type of valve devices for controlling flow of gas-phase fluid or liquid-phase fluid, or any other type of valve devices for controlling flow-rate or pressure of the fluid flowing through the valve device.

What is claimed is:

1. A valve device comprising:
a housing having a fluid passage therein, through which fluid flows;
a valve body rotatably arranged in the fluid passage for opening/closing the fluid passage and controlling an opening area thereof; and
a shaft rotatably supported in the housing for driving the valve body,
wherein a rotational axis of the shaft is inclined with respect to a center line of the fluid passage,
wherein the shaft comprises; a first shaft member receiving a driving force from an outside of the housing; and a second shaft member coaxially arranged with the first shaft member, wherein the first and second shaft members are separately arranged in the fluid passage,
wherein the valve body comprises; a disc shaped valve member for opening/closing the fluid passage; a first supporting portion provided at an outer peripheral portion of the disc shaped valve member and connected to the first shaft member; a second supporting portion provided at another outer peripheral portion of the disc shaped valve member and connected to the second shaft member, and
wherein the disc shaped valve member and the first and second supporting portions form a Z-shape when viewed in a direction parallel to a surface of the disc shaped valve member.

2. The valve device according to the claim 1, wherein
the disc shaped valve member and the first and second supporting portions are made of a press-molded metal plate.

3. The valve device according to the claim 2, further comprising:
a seal ring provided at an outer periphery of the valve body, which is in a sliding contact with an inner peripheral surface of the fluid passage so as to seal a gap between the disc shaped valve member and the inner peripheral surface of the fluid passage,
wherein the seal ring is movable with respect to and in a radial direction of the valve body.

4. The valve device according to the claim 2, further comprising:
a seal ring provided at and fixed to an outer periphery of the valve body, which is in a sliding contact with an inner peripheral surface of the fluid passage so as to seal a gap between the disc shaped valve member and the inner peripheral surface of the fluid passage,
wherein the seal ring is formed by an insert molding process.

5. The valve device according to the claim 3, wherein the valve body comprises:
a first press-molded member having the first supporting portion and a first disc shaped plate portion which forms one side surface of the disc shaped valve member; and
a second press-molded member having the second supporting portion and a second disc shaped plate portion which forms the other side surface of the disc shaped valve member.

6. The valve device according to the claim 5, wherein
the first and second press-molded members are identical and fixed to each other,
wherein first press-molded member is rotated by 180 degrees with respect the second press-molded member.

7. The valve device according to the claim 5, wherein
the seal ring is interposed between outer peripheries of the first and second disc shaped plate portions, and
the seal ring is movable in a radial direction of the valve body.

8. The valve device according to the claim 7, wherein
the seal ring is formed of an O-shaped seal ring having no cut portion in its circumferential direction.

9. The valve device according to the claim 7, wherein
the seal ring is formed of a combination of;
an O-shaped seal ring having no cut portion in its circumferential direction, and
a C-shaped seal ring having a cut portion in its circumferential direction.

10. The valve device according to the claim 7, wherein
the seal ring is formed of a combination of two C-shaped seal rings, each having a cut portion in its circumferential direction.

11. The valve device according to the claim 5, wherein
a part of the first disc shaped plate portion is punched-out and bent to form the first supporting portion, so that a punch-out opening is formed in the first disc shaped plate portion,
a part of the second disc shaped plate portion is punched-out and bent to form the second supporting portion, so that a punch-out opening is formed in the second disc shaped plate portion,
the punch-out opening of one of the first and second disc shaped plate portions is closed by the other disc shaped plate portion.

12. The valve device according to the claim 11, wherein
an annular groove is formed between outer peripheries of the first and second disc shaped plate portions,
a first seal portion is formed between the annular groove and the seal ring arranged in the annular groove,
a second seal portion is formed between the first and second disc shaped plate portions and at an area surrounding the punch-out opening,
a third seal portion is formed between the first and second disc shaped plate portions and at an area surrounding a locating hole, and
the first to third second seal portions are made of silicon gel.

13. The valve device according to the claim 11, wherein
an intermediate plate member is interposed between the first and second disc shaped plate portions,
a first seal portion is formed between the first and second disc shaped plate portions and at an outer periphery of the intermediate plate member,
a second seal portion is formed between the first and second disc shaped plate portions and at a surrounding area for the punch-out opening,
a third seal portion is formed between the first and second disc shaped plate portions and at a surrounding area for a locating hole, and
the first to third seal portions are made of sealing projections, which are formed in the intermediate plate member and flattened out between the first and second disc shaped plate portions.

14. The valve device according to the claim 4, wherein
the disc shaped valve member and the first and second supporting portions are made of a press-molded metal plate.

15. The valve device according to the claim 14, wherein
a through-hole is formed at a center of the disc shaped valve member, so that a screw-driver may be inserted through the through-hole during an assembling process,
a cap member is attached to the disc shaped valve member for closing the through-hole.

16. The valve device according to the claim 1, wherein
the first supporting portion is rotated together with the first shaft member, and
the second supporting portion is rotated together with the second shaft member.

17. The valve device according to the claim 1, wherein
the first supporting portion is rotated together with the first shaft member, and
the second supporting portion is rotattably connected to the second shaft member.
